(19) United States
(12) Patent Application Publication
(10) Pub. No.: US 2026/0077588 A1
(43) Pub. Date: Mar. 19, 2026

(54) EJECTION HEAD AND EJECTION APPARATUS

(71) Applicant: CANON KABUSHIKI KAISHA, Tokyo (JP)

(72) Inventors: YUHEI HARADA, Kanagawa (JP); TOSHIO NEGISHI, Kanagawa (JP)

(21) Appl. No.: 19/318,129

(22) Filed: Sep. 3, 2025

(30) Foreign Application Priority Data
Sep. 13, 2024 (JP) 2024-159161

(51) Int. Cl. B41J 2/045; B41J 2/14; B41J 2/17

(52) U.S. Cl. CPC B41J 2/04551; B41J 2/04541; B41J 2/04543; B41J 2/04548; B41J 2/04568; B41J 2/04573; B41J 2/0458; B41J 2/14072; B41J 2/1707; B41J 2002/14491; B41J 2202/20

(57) ABSTRACT

An ejection head includes multiple ejector modules each including an ejector driver element and an ejector heater capable of connecting with the ejector driver element; multiple circulator modules each arranged in a pair with the ejector module, and including a circulator driver element and a circulator heater capable of connecting with the circulator driver element; a group selection circuit configured to select at least one ejector group from among ejector groups into which the multiple ejector modules are divided by a predetermined number, and select at least one circulator group from among circulator groups into which the multiple circulator modules are divided by the predetermined number; and a control unit configured to determine whether or not to enable each of the selections by the group selection circuit based on an operation mode.

### BACKGROUND

### Field of the Technology

The aspect of the embodiments relates to an ejection head and an ejection apparatus to eject a liquid while circulating the liquid.

### Description of the Related Art

Among conventional circulation-type liquid ejection apparatuses in which liquids (also called inks) are circulated, a liquid ejection apparatus is known in which circulator driver elements other than ejector driver elements to eject inks cause the inks to circulate in circulation channels that communicate with ejection orifices. International Publication No. WO2018/190872 (hereinafter referred to as Document 1) discloses a technique for freely individually selecting each of ejector driver elements and circulator driver elements.

### SUMMARY

An ejection head according to an aspect of the embodiments includes: an ejector module including an ejector driver element and an ejector heater capable of connecting with the ejector driver element; a circulator module arranged in a pair with the ejector module, and including a circulator driver element and a circulator heater capable of connecting with the circulator driver element; a group selection circuit configured to select at least one ejector group from among ejector groups into which a plurality of the ejector modules are divided by a predetermined number, and select at least one circulator group from among circulator groups into which a plurality of the circulator modules are divided by the predetermined number; and a control unit configured to determine whether or not to enable each of the selections by the group selection circuit based on an operation mode.

Features of the disclosure will become apparent from the following description of embodiments with reference to the attached drawings. The following description of embodiments is described by way of example.

### BRIEF DESCRIPTION OF THE DRAWINGS

FIG. 1A is a perspective view schematically illustrating a liquid ejection apparatus in which a main ink tank as a liquid reservoir is provided outside a liquid ejection head.

FIG. 1B is a perspective view schematically illustrating a liquid ejection apparatus in which subtanks are provided immediately on top of a liquid ejection head.

FIG. 2A is an exploded perspective view of the liquid ejection head in FIG. 1.

FIG. 2B is a view illustrating an example in which one ejector element board is formed per four colors.

FIG. 2C is a view illustrating an example in which one ejector element board is formed per two colors.

FIG. 2D is a view illustrating an example in which one ejector element board is formed per color.

FIG. 3 is a diagram illustrating an example of a circuit configuration of the ejector element board in FIGS. 2A to 2D.

FIG. 4A is a diagram illustrating an example of an internal wiring configuration in a control data supply circuit in FIG. 3.

FIG. 4B is a diagram showing an example of a circuit configuration of a circulator group selection circuit in FIG. 4A and an example of a circuit configuration of an ejector group selection circuit in FIG. 4A.

FIG. 5 is a plan view of an ejector element board.

FIG. 6 is a plan view of an ejector element board.

FIG. 7 is a plan view of an ejector element board.

FIG. 8 is a plan view of an ejector element board.

### DESCRIPTION OF THE EMBODIMENTS

Hereinafter, embodiments of the disclosure will be described in detail in reference to the attached drawings. The following embodiments are not intended to limit the matters disclosed herein. In addition, all the combinations of features described in the following embodiments are not necessarily essential for the solution of the disclosure. Herein, the same constituent elements will be designated with the same reference sign.

### Outline

In a liquid ejection head, for example, an ink in ejection orifices for ink ejection is thickened in some cases as a result of evaporation of volatile components in the ink from the ejection orifices. Due to such thickening of the ink, an ink ejection velocity or the like may change, which results in ejection defects including a deterioration of ink landing accuracy. In particular, in a case where an ink ejection operation is paused for a long period of time, the ink viscosity increases significantly and solid components in the ink stick to the insides of the ejection orifices, resulting in an increase in the ink flow resistance and making it more likely to cause ejection defects.

As one of solutions to such a liquid thickening phenomenon, there has been known a method of feeding a fresh liquid to the ejection orifices in liquid chambers. As means for the method of feeding a liquid, a pump on a main body side provided separately from a fluid die to perform ejections is used to generate a pressure difference, thereby circulating a liquid in a head. As other means, there is known a method in which a fluid die itself includes a circulator element to circulate the liquid. Regarding the circulator element of the fluid die itself, a method is also known which uses a heating element to generate bubbles, thereby circulating the liquid (referred to as Case 1). For Case 1, a structure has been disclosed in which a fluid die includes a flow energy generation element (hereinafter also referred to as a circulator driver element), and causes the liquid to circulate in each of channels extended to cross an ejection orifice arrays, while causing the liquid to flow through each of the ejection orifice arrays between both ends of each of the channels.

In Case 1, an address line is assigned to each of ejection energy generation elements (hereinafter also referred to as ejector driver elements) and circulator driver elements. In a case where an address is simply specified for each driver element, drive data may be required for each driver element and the amount of data increases as the number of driver elements increases. As an example of the solution to this, there is a conceivable configuration to automatically select a circulator driver element according to a bit selection for an ejector driver element. Specifically, in a case where an ejector heater simultaneous-on selection signal and a time-division selection signal are used, the above configuration selects an ejector heater if the ejector heater simultaneous-on selection signal is “1” and selects a pump heater (hereinafter also referred to as a circulator heater) if the signal is “0”. However, as a result of studies by the inventors, it was found that this configuration inevitably selects the circulator driver element at the same time as driving of the ejector driver element and therefore has no way to drive one of the elements alone.

To address this, in the disclosure, a group selection circuit selects at least one ejector group from among ejector groups into which multiple ejector modules are divided by a predetermined number. In addition, the group selection circuit selects at least one circulator group from among multiple circulator groups into which multiple circulator modules are divided by the predetermined number. Then, whether or not to enable each of the selections by the group selection circuit is determined based on an operation mode. According to this control, either of the ejector driver elements or the circulator driver elements can be driven independently. Hereinafter, the disclosure will be described in detail.

### Liquid Ejection Apparatus 50

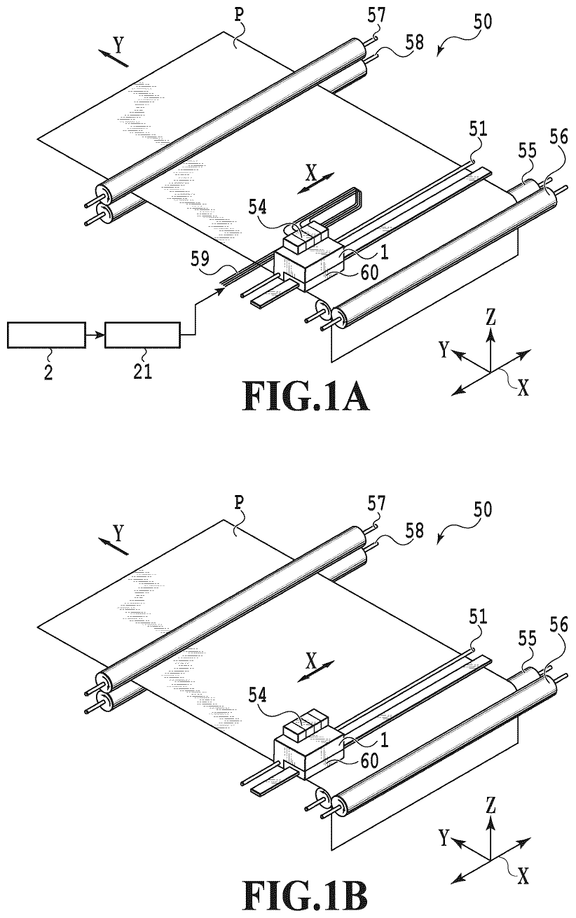

FIGS. 1A and 1B are views illustrating examples of an overall structure of a liquid ejection apparatus 50. FIG. 1A is a perspective view schematically illustrating the liquid ejection apparatus 50 in which a main ink tank 2 as a liquid reservoir is provided outside a liquid ejection head 1. FIG. 1B is a perspective view schematically illustrating a liquid ejection apparatus 50 in which ink-sub-tanks 54 are provided immediately on top of a liquid ejection head 1. First, points common to FIGS. 1A and 1B will be described.

The liquid ejection apparatus 50 includes the liquid ejection head 1 and conveyance rollers 55, 56, 57, and 58. The liquid ejection head 1 is capable of scanning in a direction X crossing a direction Y in which an ejection receiving medium P is conveyed. The liquid ejection head 1 is mounted on a carriage 60. The carriage 60 reciprocates along a guide shaft 51 in a main scanning direction (also called the direction X). The conveyance rollers 55, 56, 57, and 58 convey the ejection receiving medium P in a sub scanning direction (also called the conveyance direction Y) crossing (orthogonal to in the embodiment) the main scanning direction. In other words, the liquid ejection apparatus 50 constitutes a serial inkjet liquid ejection apparatus by ejecting liquids from the liquid ejection head 1 onto the ejection receiving medium P being conveyed in the conveyance direction Y, while scanning the liquid ejection head 1 in the direction X. Note that the application of the disclosure is not limited to the serial inkjet liquid ejection apparatus. Using a line head (page-wide head) that is long in a page-width direction of an ejection receiving medium P, the disclosure may be applied to a page-wide inkjet liquid ejection apparatus to eject liquids onto an ejection receiving medium P being conveyed in the conveyance direction Y. In FIGS. 1A and 1B, a direction Z indicates a vertical direction. Specifically, the direction Z is a direction crossing (orthogonal to in the embodiment) a X-Y plane specified by the direction X and the conveyance direction Y.

The liquid ejection head 1 is capable of ejecting four types of inks, namely, black (K), cyan C, magenta (M), and yellow (Y) inks. The liquid ejection head 1 is capable of printing full-color images by ejecting these four types of inks. Note that, inks that can be ejected from the liquid ejection head 1 are not limited to the above four types of inks. For example, the disclosure may be applied to a liquid ejection head 1 to eject another type of ink such as a spot color of ink. In summary, the types and number of inks ejected from the liquid ejection head 1 are not limited.

Next, different points between FIGS. 1A and 1B will be described. In FIG. 1A, ink-sub-tanks 54 are mounted on the liquid ejection head 1. To the ink-sub-tanks 54, four ink supply tubes (liquid communication paths) 59 are attached. The liquid ejection apparatus 50 also includes an ink tank 2 and an external pump 21. The ink tank 2 reserves the inks. The inks reserved in the ink tank 2 are supplied to the ink-sub-tanks 54 via the four ink supply tubes 59 by driving force of the external pump 21. On the other hand, in FIG. 1B, the ink-sub-tanks 54 are provided immediately on top of the liquid ejection head 1. In FIG. 1B, a difference from FIG. 1A is that the ink tank 2 is not provided outside the liquid ejection head 1 and therefore none of the four ink supply tubes 59 and the external pump 21 is provided. In both the structures of FIGS. 1A and 1B, the liquid ejection head 1 may be provided integrally with the ink-sub-tanks 54 and be mountable on and demountable from the carriage 60. Instead, in another possible structure, the liquid ejection head 1 may be provided integrally with the carriage 60, so that only the ink-sub-tanks 54 may be mountable on and demountable from the liquid ejection head 1. The following description will be given by using the structure in FIG. 1A.

### Liquid Ejection Head 1

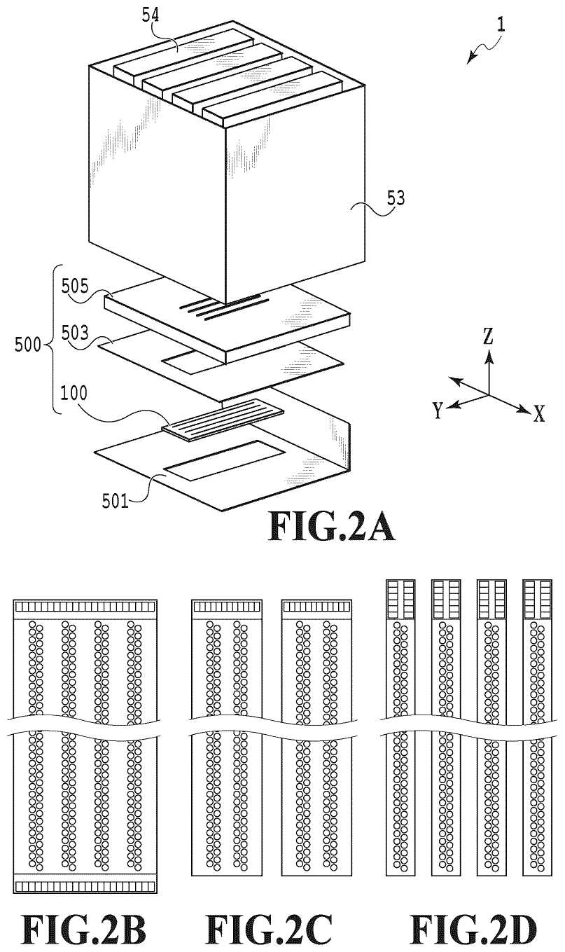

FIGS. 2A, 2B, 2C, and 2D are views illustrating an example of a basic structure of the liquid ejection head in FIG. 1. FIG. 2A is an exploded perspective view of the liquid ejection head 1 in FIG. 1. FIGS. 2B to 2D are overall views of an ejector element board 100 in FIG. 2A. The liquid ejection head 1 includes a casing 53, the ink-sub-tanks 54, and an ejector element unit 500. The ink-sub-tanks 54 are housed in the casing 53. The ejector element unit 500 is provided to a bottom portion of the casing 53. In a wall surface of the casing 53, four joints to be connected to the four ink supply tubes 59 for the respective four types of inks are provided, although not illustrated. In other words, an individual ink supply path is provided for each type of ink.

The ejector element unit 500 includes a first support member 505, a second support member 503, an ejector element board 100, and an electric wiring member 501. The first support member 505 is provided with ink supply ports and ink collection parts. The second support member 503 is provided with an opening. The ejector element board 100 is fixed to the first support member 505 with an adhesive. The first support member 505 is fixed to the second support member 503 with an adhesive. The second support member 503 holds the electric wiring member 501 and the ejector element board 100 so that the electric wiring member 501 and the ejector element board 100 are electrically connected to each other. The electric wiring member 501 applies electric signals for ink ejection and electric signals for ink circulation to the ejector element board 100. The electric signals for ink ejection and the electric signals for ink circulation will be described later in detail.

FIG. 2B illustrates an example in which one ejector element board 100 is formed per four colors. The four colors are, for example, black, cyan, magenta, and yellow, and separate arrays are formed for the respective colors. The arrays are each extended along the conveyance direction Y and are arranged at intervals in the direction X. Multiple ejection orifice included in each array are arranged at regular intervals along the Y direction. The ejection orifices in each array may be arranged on a single line along the Y direction without any gaps on the X direction. Instead, five arrays in total may be arranged for the four colors: two arrays for the black color; and three arrays for the other respective three colors. FIG. 2C illustrates an example in which one ejector element board 100 is formed per two colors. Two ejector element boards 100 may be mounted on one liquid ejection head 1. Instead, two liquid ejection heads 1 on each of which one ejector element board 100 is mounted may be prepared. FIG. 2D illustrates an example in which one ejector element board 100 is formed per color. Four ejector element boards 100 may be mounted on one liquid ejection head 1. Instead, four liquid ejection heads 1 on each of which one ejector element board 100 is mounted may be prepared. In the case where multiple ejector element boards 100 are prepared as illustrated in FIGS. 2C and 2D, the ejector element boards 100 may be different in length. In addition, any of various combinations of colors may be applied to the ejector element board(s) 100, and the same applies to the case where more than four colors in total are used. Hereinafter, the electric signals for ink ejection and the electric signals for ink circulation will be described in detail in reference to circuit configurations.

### Ejector element Board 100

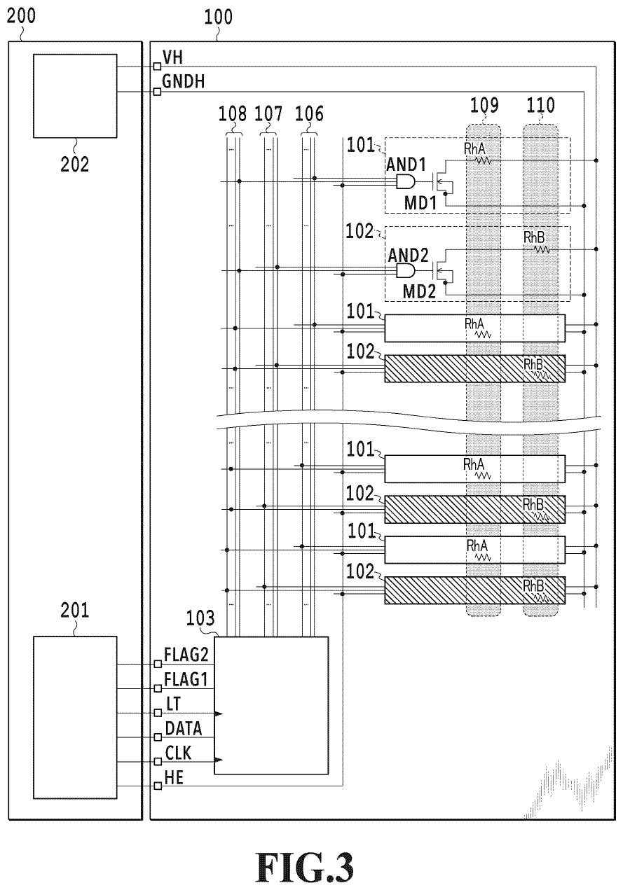

FIG. 3 is a diagram illustrating an example of a circuit configuration of the ejector element board 100 in FIGS. 2A to 2D. The ejector element board 100 is supplied with various signals from a main board 200. The main board 200 is provided in a main body of the liquid ejection apparatus and includes a controller 201 and a power supply circuit 202. The controller 201 includes a ROM, a RAM, and a CPU as main components and controls the liquid ejection head 1 by supplying various electric signals to the ejector element board 100. The controller 201 supplies the ejector element board 100 with an enable signal HE, a clock signal CLK, a data signal DATA, a latch signal LT, an ejection flag signal FLAG1, and a circulation flag signal FLAG2. The above signals will be each described later in detail. The power supply circuit 202 applies a power supply voltage VH to the ejector element board 100. The power supply circuit 202 and the ejector element board 100 are connected to each other via GNDH. The GNDH functions as a ground potential.

### Outline of Wiring

The ejector element board 100 includes multiple ejector modules 101, multiple circulator modules 102, and a control data supply circuit 103. Each circulator module 102 is arranged in a pair with an ejector module 101. Accordingly, the number of circulator modules 102 is the same as the number of ejector modules 101. Ejector group selection signal wiring 106, circulator group selection signal wiring 107, and time-division selection signal wiring 108 are routed between the multiple ejector modules 101 and the control data supply circuit 103. The ejector group selection signal wiring 106, the circulator group selection signal wiring 107, and the time-division selection signal wiring 108 are also routed between the multiple circulator modules 102 and the control data supply circuit 103.

### Ejector Module 101

Each ejector module 101 includes an ejector heater RhA, an ejector driver element MD1, and an ejector logic circuit AND1. The ejector heater RhA is formed of, for example, an electrothermal transducer element. In a state where a voltage is applied to the ejector heater RhA from the power supply voltage VH, a current flows into the ejector heater RhA if the ejector driver element MD1 is in a conductive state. The ejector driver element MD1 is formed of, for example, a metal-oxide-semiconductor field effect transistor (MOSFET). Instead, the ejector driver element MD1 may be formed of an element other than the MOSFET. For example, the ejector driver element MD1 may be formed of a bipolar transistor. Instead, the ejector driver element MD1 may be also formed of an insulated gate bipolar transistor (IGBT). The ejector logic circuit AND1 selectively drives the ejector driver element MD1. The enable signal HE, an ejector group selection signal, and an elector time-division selection signal are inputted to an input side of the ejector logic circuit AND1. The enable signal HE is transmitted from the controller 201. The enable signal HE controls a current pulse width of the ejector driver element MD1, or more specifically controls a time period for which a current continues to flow between the drain-source of the ejector driver element MD1 after the drain-source of the ejector driver element MD1 turns into the conductive state. The enable signal HE is a signal for adjusting the current pulse width so as to generate desired thermal energy with various manufacturing variations taken into consideration. The various manufacturing variations include, for example, a manufacturing variation among the resistance values of the ejector heaters RhA mounted on the ejector element board 100 and a manufacturing variation in the power supply circuit 202. In addition, the various manufacturing variations also include a voltage drop in a power supply-side wiring during simultaneous driving of multiple heaters such as the ejector heater RhA and the circulator heater RhB. The heaters to be simultaneously driven as mentioned herein are an ejector heater RhA and a circulator heater RhB arranged at a position not paired with the foregoing ejector heater RhA. The enable signal HE may be transmitted from the controller 201 via an external connection terminal (not illustrated) provided to the ejector element board 100. The ejector group selection signal is supplied from the ejector group selection signal wiring 106. The time-division selection signal is supplied from the time-division selection signal wiring 108. An output side of the ejector logic circuit AND1 is connected to a gate of the ejector driver element MD1. Thus, in the case where all the signals inputted from the input side of the ejector logic circuit AND1 are 1, the voltage is applied to the gate of the ejector driver element MD1 and the drain-source of the ejector driver element MD1 turns into the conductive state. If the drain-source of the ejector driver element MD1 is in the conductive state, a current flows into the ejector heater RhA, and the ejector heater RhA generates heat. Through this series of operations, the ink is bubbled and then ejected, so that the ink can be ejected onto an ejection receiving medium P. Although the example in which the ejector heater RhA is formed of the electro-thermal transducer element is described above, the ejector heater RhA is not particularly limited to this. For example, the ejector heater RhA may be formed of a piezo element.

### Circulator module 102

Each circulator module 102 includes a circulator heater RhB, a circulator driver element MD2, and a circulator logic circuit AND2. The circulator heater RhB is formed of, for example, an electro-thermal transducer element. In a state where a voltage is applied to the circulator heater RhB from the power supply voltage VH, a current flows into the circulator heater RhB if the circulator driver element MD2 is in a conductive state. The circulator driver element MD2 is formed of, for example, a metal-oxide-semiconductor field effect transistor (MOSFET). Instead, the circulator driver element MD2 may be formed of a transistor other than the MOSFET. For example, the circulator driver element MD2 may be formed of a bipolar transistor. Instead, the circulator driver element MD2 may be also formed of an insulated gate bipolar transistor (IGBT). The circulator logic circuit AND2 selectively drives the circulator driver element MD2. The enable signal HE, a circulator group selection signal, and a circulator time-division selection signal are inputted to an input side of the circulator logic circuit AND2. The enable signal HE is transmitted from the controller 201. The enable signal HE controls a current pulse width of the circulator driver element MD2, or more specifically controls a time period for which a current continues to flow between the drain-source of the circulator driver element MD2 after the drain-source of the circulator driver element MD2 turns into the conductive state. The enable signal HE is a signal for adjusting the current pulse width so as to generate desired thermal energy with the various manufacturing variations taken into consideration. The various manufacturing variations include, for example, a manufacturing variation among the resistance values of the circulator heaters RhB mounted on the ejector element board 100 and a manufacturing variation in the power supply circuit 202. In addition, the various manufacturing variations also include a voltage drop in the power supply-side wiring during simultaneous driving of multiple heaters such as the circulator heater RhB and the ejector heater RhA. The enable signal HE may be transmitted from the controller 201 via the external connection terminal (not illustrated) provided to the ejector element board 100. The circulator group selection signal is supplied from the circulator group selection signal wiring 107. The time-division selection signal is supplied from the time-division selection signal wiring 108. An output side of the circulator logic circuit AND2 is connected to a gate of the circulator driver element MD2. Thus, in the case where all the signals inputted from the input side of the circulator logic circuit AND2 are 1, the voltage is applied to the gate of the circulator driver element MD2 and the drain-source of the circulator driver element MD2 turns into the conductive state. If the drain-source of the circulator driver element MD2 is in the conductive state, a current flows into the circulator heater RhB and the circulator heater RhB generates heat. Through this series of operations, bubbles of the ink are grown, so that a circulation flow can be generated in an ink circulation channel. Although the example in which the circulator heater RhB is formed of the electro-thermal transducer element is described above, the circulator heater RhB is not particularly limited to this. For example, the circulator heater RhB may be formed of a piezo element.

Here, regarding the aforementioned enable signal HE, a single enable signal HE is shared for ejection purpose and for circulation purpose in order to reduce the number of signal terminals. This means that the current pulse width cannot be controlled independently for ejection or circulation. Therefore, on the premise that the ejector heater RhA and the circulator heater RhB are manufactured in the same lot of a semiconductor manufacturing process and are finished with the same manufacturing variation (amount of deviation in a resistance value from an ideal value), the current pulse width may be adjusted by a single enable signal HE.

### Control Data Supply Circuit 103

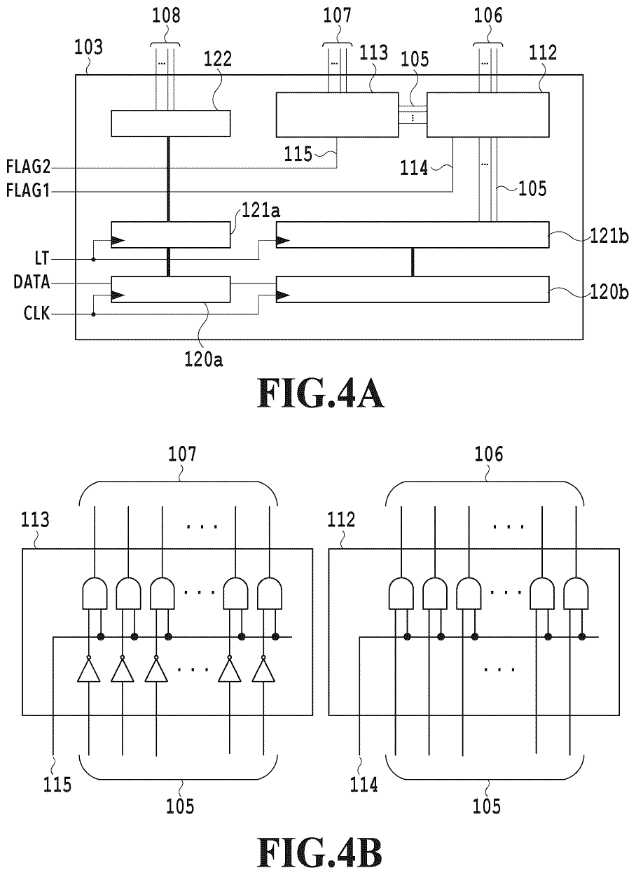

FIGS. 4A and 4B are diagrams illustrating an example of a circuit configuration of the control data supply circuit 103 in FIG. 3. FIG. 4A is a diagram illustrating an example of an internal wiring configuration in the control data supply circuit 103 in FIG. 3. FIG. 4B is a diagram illustrating an example of a circuit configuration of a circulator group selection circuit 113 in FIG. 4A and an example of a circuit configuration of an ejector group selection circuit 112 in FIG. 4A. The control data supply circuit 103 includes shift registers 120a and 120b, latch circuits 121a and 121b, a decoder circuit 122, the circulator group selection circuit 113, and the ejector group selection circuit 112. The control data supply circuit 103 is provided with external connection terminals. The control data supply circuit 103 is supplied with the clock signal CLK, the data signal DATA, the latch signal LT, the ejection flag signal FLAG1, and the circulation flag signal FLAG2 from the controller 201 via the external connection terminals. The clock signal CLK is a signal to be used for serial data transfer of the data signal DATA to the shift registers 120a and 120b. The data signal DATA contains selection information of the ejector modules 101 and selection information of the circulator modules 102. The latch signal LT is a signal according to which the latch circuits 121a and 121b obtain and hold information stored in the shift registers 120a and 120b, respectively, in latch cycles. The decoder circuit 122, the circulator group selection circuit 113, and the ejector group selection circuit 112 will be described later in detail.

### Driving Control of Ejector Heater RhA

Description will be given of driving control of the ejector heaters RhA based on an ejector heater array 109. The ejector heater array 109 includes m groups. Each group includes n ejector heaters RhA. Each ejector heater RhA is arranged right below an ink ejection orifice. In a case where one group is selected, the n ejector heaters RhA in that group are operated one after another in a time-divided manner. Here, description will be given of driving control of (n=16 heaters)×(m=40 groups) ejector heaters RhA arrayed at a density per inch of 600 dpi in an ejector heater array.

### Time-Division Control in One Group

An ejector heater RhA is included in each ejector module 101 as described above. One group includes n ejector heaters RhA. Accordingly, one group includes n ejector modules 101. Since n is assumed to equal 16, the 16 ejector modules 101 are driven in the time-divided manner according to the time-division selection signal. The time-divided driving means control of dividing a time period for one ejection cycle into n=16 time units and sequentially selecting one of the ejector modules 101 in each of the divided time units. Here, two or more of the ejector modules 101 in the same group are not selected simultaneously. All the ejector modules 101 included in the same group are selected once in one ejection cycle. In this time-divided driving, in one embodiment, one wire line of the time-division selection signal wiring 108 is selected. Thus, the configuration in which the decoder circuit 122 is included in the control data supply circuit 103 makes it possible to further reduce the amount of data to be serially transferred from the main board 200.

### Decoder Circuit 122; Time-Division Control

The decoder circuit 122 is a circuit to expand q bits of input data to 2^{q} bits of output data. Specifically, if 4 bits of input data are inputted to the decoder circuit 122, the decoder circuit 122 converts the 4 bits of input data into 16 (=the fourth power of 2) bits of output data. Here, the output data of the decoder circuit 122 is outputted as information in which 1 bit is enabled among 16 bits. This makes it possible to perform the time-divided driving. Here, unless there is a special purpose, in one embodiment, all wire lines of the time-division selection signal wiring 108 to which the output data is outputted from the decoder circuit 122 be used for the time-division selection signal in terms of input data utilization efficiency. As the amount of data to be serially transferred increases, in one embodiment, faster serial transfer may be required. Since such faster serial transfer results in increases in the cost and sizes of signal transmission circuits, signal reception circuits, and transmission lines in the main board 200 and the ejector element board 100, in one embodiment, the amount of data is reduced as much as possible.

### Group Selection Control

The control data supply circuit 103 outputs m bits of an ejector group selection signal for selectively driving any one of the m groups. In the case where one group is selected from the m groups, the n ejector modules 101 included in that one group can be selected simultaneously. The main board 200 serially transfers m bits of information where m equals the number of the groups. As described above, in response to input of the enable signal HE, the ejector group selection signal, and the time-division selection signal to the ejector logic circuit AND1, the ejector module 101 is selected and controlled so that a current flows into the ejector heater RhA located at the corresponding position. Although the example on the assumption of n=16 and m=40 is described in the embodiment, the disclosure is not particularly limited to this. For example, n=8 and m=80 may be set. Instead, the nozzle length may be different from that in the embodiment, and n=32 and m=40 or the like may be set. However, since n specifies the number of time divisions, in one embodiment, n is a value expressed as a power of 2 (n=2, 4, 8, 16, 32, . . . ) in order to use the output signal from the decoder circuit 122 as the selection signal.

### Driving Control of Circulator Module 102

Description will be given of driving control of the circulator heaters RhB based on a circulator heater array 110. The circulator heater array 110 includes m groups as in the ejector heater array 109. Each group includes n circulator heaters RhB as in the ejector heater array 109. Each circulator heater RhB is arranged close to the ejector heater RhA in a pair. In a case where one group is selected, the n circulator heater RhB in that one group are operated one after another in a time-divided manner. Here, description will be given of driving control of (n=16 heaters)×(m=40 groups) circulator heaters RhB.

### Time-Division Control in One Group

A circulator heater RhB is included in each circulator module 102 as described above. One group includes n circulator heaters RhB. Accordingly, one group includes n circulator modules 102. Since n is assumed to equal 16, the 16 circulator modules 102 are driven in the time-divided manner according to the time-division selection signal with the same number of time divisions as in the ejector modules 101. The decoder circuit 122 is included in the control data supply circuit 103 in order to reduce the amount of data to be serially transferred as the time-division selection signal from the main board 200.

### Group Selection Control

The control data supply circuit 103 outputs m bits of a circulator group selection signal for selectively driving any one of the m groups. In the case where one group is selected from the m groups, the n circulator modules 102 included in that one group can be selected simultaneously. The main board 200 serially transfers m bits of information, which is the same number as the number of groups. As described above, in response to input of the enable signal HE, the circulator group selection signal, and the time-division selection signal to the circulator logic circuit AND2, the circulator module 102 is selected and controlled so that a current flows into the circulator heater RhB located at the corresponding position. The circulator group selection signal is transferred from the circulator group selection circuit 113 via the circulator group selection signal wiring 107. The circulator group selection circuit 113 is included in the control data supply circuit 103.

### Circulator Group Selection Circuit 113

The circulator group selection circuit 113 generates a circulator group selection signal based on selection information in a group selection generation signal. As illustrated in FIG. 4B, the circulator group selection circuit 113 includes a NOT circuit and an AND circuit. The result of the logical AND between a signal obtained by the NOT circuit logically inverting the group selection generation signal obtained from group selection generation signal wiring 105 and the circulation flag signal FLAG2 obtained from circulation flag signal wiring 115 is processed as follows. Specifically, the result of the logical AND is outputted as the circulator group selection signal to the circulator group selection signal wiring 107. Thus, in the state where the ejector modules 101 are selected, the circulator modules 102 are not selected. On the other hand, in the state where the ejector modules 101 are not selected and the circulation flag signal FLAG2 is high, the circulator modules 102 are selected. The group selection generation signal obtained from the group selection generation signal wiring 105 is the signal obtained by the latch circuit 121b. The information held in the latch circuit 121b is the information obtained from the shift register 120b. The information held in the shift register 120b is the information obtained from the data signal DATA. In other words, the data signal DATA contains the selection information in the group selection generation signal.

### Ejector Group Selection Circuit 112

The ejector group selection circuit 112 generates an ejector group selection signal based on the selection information in the group selection generation signal. As illustrated in FIG. 4B, the ejector group selection circuit 112 includes an AND circuit. The result of the logical AND between the group selection generation signal obtained from the group selection generation signal wiring 105 and the ejection flag signal FLAG1 obtained from ejection flag signal wiring 114 is processed as follows. Specifically, the result of the logical AND is outputted as the ejector group selection signal to the ejector group selection signal wiring 106. Thus, in a state where the ejector modules 101 are selected and the ejection flag signal FLAG1 is high, the ejector modules 101 are selected. On the other hand, in a state where the ejector modules 101 are even selected but the ejection flag signal FLAG1 is low, the ejector modules 101 are not selected. In other words, the ejector modules 101 are not selected on a group basis.

Here, the liquid ejection apparatus can be controlled as in the following use cases.

### First Use Case

As a first use case, an operation mode is considered in which a normal ejection operation not needing ink circulation is performed. In the first use case, the selection of the circulator modules 102 can be disabled under the setting that the circulation flag signal FLAG2 is low, in other words, is disabled. For example, an operation mode in which the selection of the circulator modules 102 by the circulator group selection circuit 113 is disabled and the selection of the ejector group by the ejector group selection circuit 112 is enabled is set as a first mode. The liquid ejection apparatus may be operated based on the first mode.

### Second Use Case

As a second use case, an operation mode is considered in which ink circulation is performed without ink ejection. In the second use case, the selection of the ejector modules 101 can be disabled under the setting that the ejection flag signal FLAG1 is low, in other words, is disabled. For example, an operation mode in which the selection of the ejector group by the ejector group selection circuit 112 is disabled and the selection of the circulator modules 102 by the circulator group selection circuit 113 is enabled is set as a second mode. The liquid ejection apparatus may be operated based on the second mode.

### Third Use Case

As a third use case, an operation mode is considered in which ink ejection and ink circulation are performed simultaneously. In the third use case, the ink ejection and the ink circulation can be permitted to be performed simultaneously under the settings that both the ejection flag signal FLAG1 and the circulation flag signal FLAG2 are high, in other words, are enabled. For example, an operation mode in which the selection of the circulator modules 102 by the circulator group selection circuit 113 is enabled and the selection of the ejector group by the ejector group selection circuit 112 is enabled is set as a third mode. The liquid ejection apparatus may be operated based on the third mode. In one embodiment, the ejection flag signal FLAG1 and the circulation flag signal FLAG2 are serially transferred from the main body of the liquid ejection apparatus via the external connection terminals.

In the embodiment, a common power supply voltage VH (for example, 24 V) as the power supply voltage and a common GNDH as the ground potential are connected to the ejector modules 101 and the circulator modules 102. However, in order to further reduce fluctuations in ejection energy caused by a voltage drop during driving of the ejector heaters RhA and the circulator heaters RhB, the following measure may be taken. Specifically, for each of the power supply voltage and the ground potential, the ejector element board 100 may be provided with supply wiring and an external connection terminal dedicated to each of the sets of the ejector modules 101 and the circulator modules 102. In other words, the power supply circuit 202 mounted on the main board 200 may supply the power supply voltage and the ground potential individually to each of the above sets.

In general, a driver element is operated with a higher voltage than that for a logic circuit. For this reason, a circuit board is used in which high-voltage driver elements and standard driver elements coexist. In the embodiment, the ejector driver elements MD1 and the circulator driver elements MD2 may be formed of double-diffused MOSFET (DMOS) transistors, which are high-voltage MOS transistors. The logic circuits such as the ejector logic circuits AND1, the circulator logic circuits AND2, the circulator group selection circuit 113 and the other shift registers 120a and 120b, latch circuits 121a and 121b, and decoder circuit 122 may be formed of low-voltage MOS transistors.

### Circuit Area

A drive current for the circulator heater RhB generates thermal energy for circulating the ink in the dedicated channel. In a case where the drive current of the circulator heater RhB is smaller than the drive current of the ejector heater RhA for ejection to an ejection receiving medium, the DMOS transistor functioning as the circulator heater RhB may have a small current drive capability. Accordingly, in one embodiment, a configuration is such that the area of the circulator driver element MD2 is smaller than the area of the ejector driver element MD1 because there is no need to make the area of the circulator driver element MD2 larger than the area of the ejector driver element MD1.

### First Case of Circuit Layout

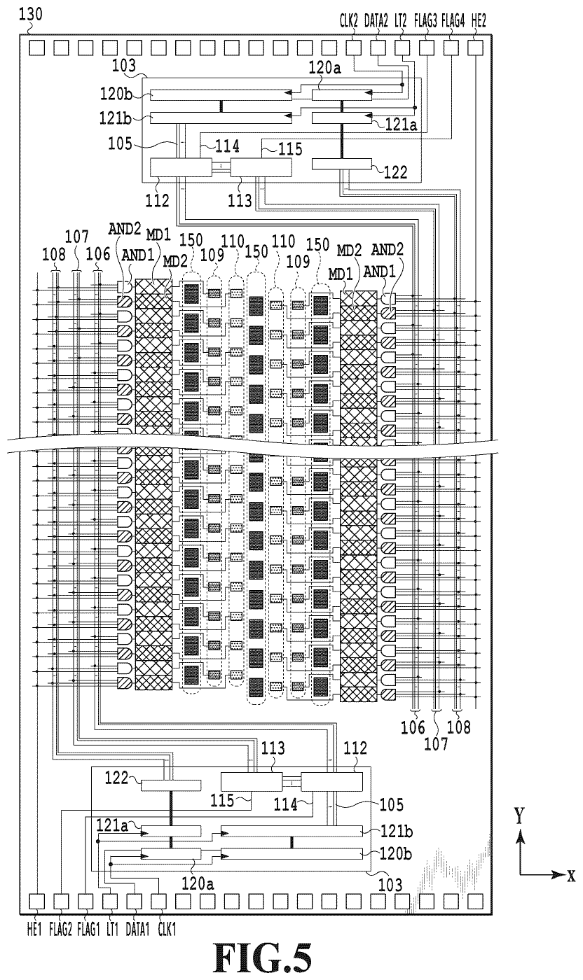

FIG. 5 is a plan view of an ejector element board 130. In an example in FIG. 5, two mechanisms each for selectively controlling the control data supply circuit 103 to the ejector heater array 109 and the circulator heater array 110 are arranged in point symmetry with respect to the center of the ejector element board 130. In FIG. 5, three ink supply port arrays 150 each extending in the conveyance direction Y are arranged at intervals in the direction X. Between neighboring two of the ink supply port arrays 150, one ejector heater array 109 and one circulator heater array 110 are arranged along the conveyance direction Y. In each of a region left to the left ink supply port array 150 and a region right to the right ink supply port array 150 among the three ink supply port arrays 150, the following components are arrayed. Specifically, the ejector driver elements MD1, the circulator driver elements MD2, the ejector logic circuits AND1, the circulator logic circuits AND2, the ejector group selection signal wiring 106, the circulator group selection signal wiring 107, and the time-division selection signal wiring 108 are arrayed.

The external connection terminals are arrayed along the direction X at both the upper and lower board ends of the ejector element board 130 in the conveyance direction Y. One control data supply circuit 103 is arranged in each of regions between the external connection terminals and the ink supply port arrays 150. Since regions between the external connection terminals and the ink supply port arrays 150 are present at two positions, namely, upper and lower positions in the conveyance direction Y, two control data supply circuits 103 are arranged at the two positions, namely, upper and lower positions in the conveyance direction Y.

As illustrated in FIG. 5, the ejector element board 130 is configured such that the external connection terminals and the control data supply circuits 103 are arranged at both ends in the conveyance direction Y as described above, and accordingly the board dimension of the ejector element board 130 in the direction X can be made small. Assuming that the above layout configuration of the ejector element board 130 is considered as one unit, multiple layout configurations defined above may be arranged side by side in the direction X, so that multiple mechanisms for multiple types of inks can be mounted on one ejector element board 130, although not illustrated.

### Second Case of Circuit Configuration

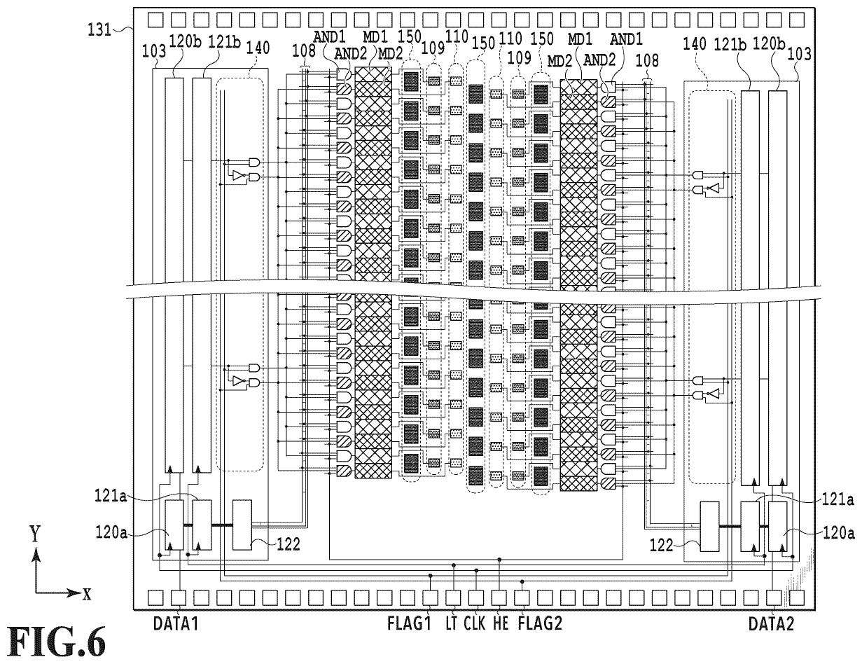

FIG. 6 is a plan view of an ejector element board 131. In FIG. 6, a group selection circuit 140 represents a combination of the ejector group selection circuit 112 and the circulator group selection circuit 113. The control data supply circuits 103 are arranged at two positions, namely, right and left ends of the ejector element board 131 in the direction X. The ejector element board 131 in FIG. 6 can achieve a layout with a slightly larger board dimension in the direction X but a smaller board dimension in the conveyance direction Y than in the example in FIG. 5. In addition, the area of the ejector element board 131 can be made smaller than in the example in FIG. 5.

### Third Case of Circuit Layout

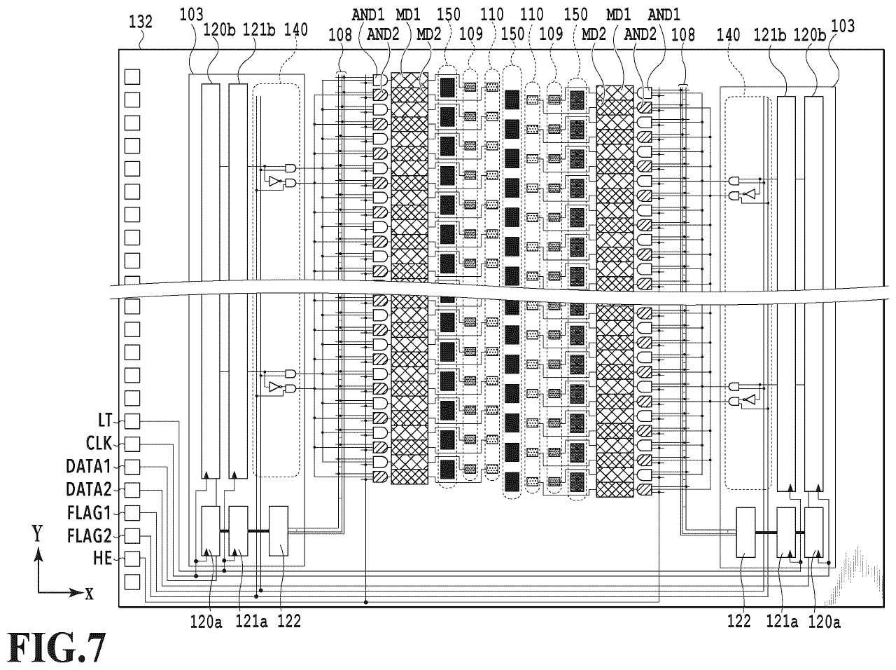

FIG. 7 is a plan view of an ejector element board 132. In the ejector element board 132 in FIG. 7, the external connection terminals are arranged on one corner side as compared with the ejector element board 131 in FIG. 6. This layout configuration makes it possible to reduce the board dimension in the Y direction. In a case of a liquid ejection head in which multiple chips as the ejector element boards 132 are mounted along the nozzle array direction, the configuration in which the external connection terminals are not provided on extensions of the nozzle arrays allows the distance between the ejector element boards to be smaller than otherwise, thereby enabling the size of the liquid ejection head to be reduced.

### Four Case of Circuit Layout

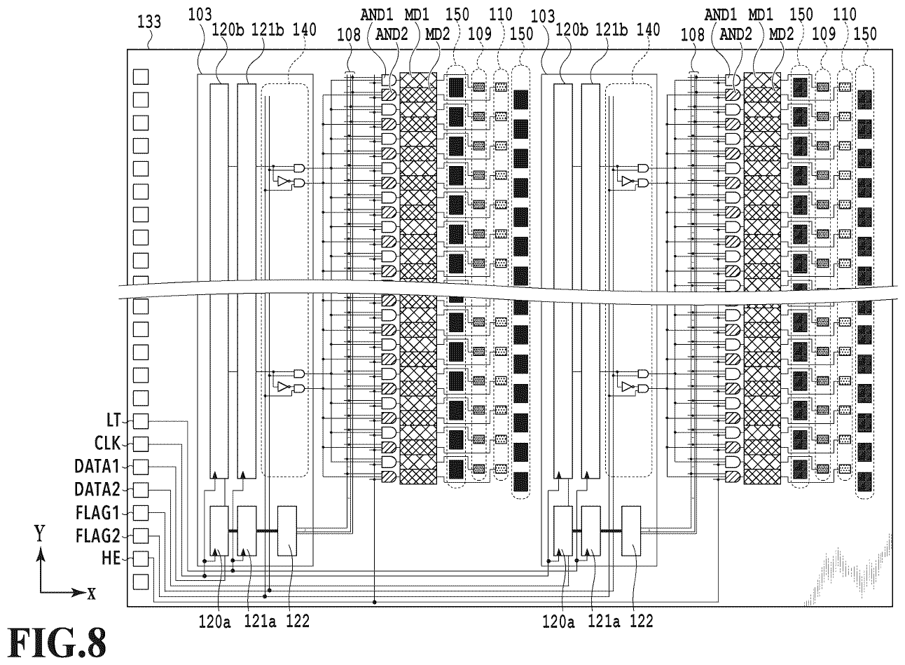

FIG. 8 is a plan view of an ejector element board 133. In FIG. 8, units each including the control data supply circuit 103, the ink supply port array 150, the ejector heater array 109, the circulator heater array 110, the ink supply port array 150, and so on are arranged side by side in the direction X. This is a configuration, assuming a case where different types of inks are to be supplied to the ink supply port arrays 150 in the ejector element board 133, in which the ink supply port arrays 150 in one of the units are located far from the ink supply port arrays 150 in the other unit. This configuration makes it possible to avoid color mixing of the different types of inks during ejection.

### Other Embodiments

The various examples and embodiments of the disclosure are presented and described above, but the spirit and scope of the disclosure should not be limited to the specific description given herein. The disclosure is not limited to the above embodiments but may be modified or altered in various ways. The disclosure may be carried out by combining some features in the above embodiments.

### (Modification 1)

For example, the above embodiments are described based on the example where the ejector driver elements MD1 and the circulator driver elements MD2 are formed of the DMOS transistors, but the disclosure is not particularly limited to this. For example, at least either of the ejector driver elements MD1 or the circulator driver elements MD2 may be formed of silicon carbide (SiC) MOSFETs.

### (Modification 2)

In addition, the example in which the ejection flag signal FLAG1 and the circulation flag signal FLAG2 are supplied from the controller 201 to the ejector element board 100 is described, but the disclosure is not particularly limited to this. For example, the ejection flag signal FLAG1 and the circulation flag signal FLAG2 may be each extracted by an internal process in the decoder circuit 122. Specifically, the decoder circuit 122 may include an ejection flag extraction filter and a circulation flag extraction filter. For example, the data signal DATA to be inputted to the decoder circuit 122 is extended in data length and provided with a flag region. This flag region holds both of the ejection flag signal FLAG1 and the circulation flag signal FLAG2. The ejection flag signal FLAG1 and the circulation flag signal FLAG2 can be extracted from the data signal DATA through the ejection flag extraction filter and the circulation flag extraction filter. The circulation flag signal FLAG2 as extracted above may be transmitted to the circulator group selection circuit 113 via wiring not illustrated, for example. The ejection flag signal FLAG1 as extracted above may be transmitted to the ejector group selection circuit 112 via wiring not illustrated, for example. The transmission timing may be adjusted by using the latch signal LT or the clock signal CLK.

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

According to the disclosure, it is possible to independently drive either the ejector driver elements or the circulator driver elements.

This application claims the benefit of Japanese Patent Application No. 2024-159161, filed Sep. 13, 2024, which is hereby incorporated by reference herein in its entirety.

What is claimed is:

1. An ejection head comprising:
an ejector module including an ejector driver element and an ejector heater capable of connecting with the ejector driver element;
a circulator module arranged in a pair with the ejector module, and including a circulator driver element and a circulator heater capable of connecting with the circulator driver element;
a group selection circuit configured to select at least one ejector group from among ejector groups into which a plurality of the ejector modules are divided by a predetermined number, and select at least one circulator group from among circulator groups into which a plurality of the circulator modules are divided by the predetermined number; and
a control unit configured to determine whether or not to enable each of the selections by the group selection circuit based on an operation mode.

2. The ejection head according to claim 1, wherein
the operation mode includes at least one of a first mode, a second mode, and a third mode,
the first mode is a mode to disable the selection of the circulator modules by the group selection circuit and to enable the selection of the ejector modules by the group selection circuit,
the second mode is a mode to disable the selection of the ejector modules by the group selection circuit and to enable the selection of the circulator modules by the group selection circuit, and
the third mode is a mode to enable the selection of the circulator modules by the group selection circuit and enable the selection of the ejector modules by the group selection circuit.

3. The ejection head according to claim 1, wherein
the group selection circuit includes an ejector group selection circuit,
the ejector group selection circuit includes an ejector AND circuit, and
the ejector AND circuit receives input of a group selection generation signal specifying a selection of at least one ejector group from among the ejector groups and an ejection flag signal specifying whether or not to enable the selection specified in the group selection generation signal.

4. The ejection head according to claim 1, wherein
the group selection circuit includes a circulator group selection circuit,
the circulator group selection circuit includes a circulator AND circuit,
the circulator AND circuit receives input of a group selection generation signal specifying a selection of at least one circulator group from among the circulator groups and a circulation flag signal specifying whether or not to enable the selection specified in the group selection generation signal.

5. The ejection head according to claim 3, further comprising:
an external connection terminal; and
a shift register configured to receive input of the ejection flag signal from the external connection terminal and hold the ejection flag signal, wherein
the ejector AND circuit receives input of the ejection flag signal held by the shift register.

6. The ejection head according to claim 4, further comprising:
an external connection terminal; and
a shift register configured to receive input of the circulation flag signal from the external connection terminal and hold the circulation flag signal, wherein
the circulator AND circuit receives input of the circulation flag signal held by the shift register.

7. The ejection head according to claim 1, further comprising a decoder circuit configured to expand a number of input bits in input data to a number of output bits of output data, where the number of output bits equals a number obtained by exponentiation using 2 as a base and the number of input bits as an exponent, the number of output bits being for use as a number of time divisions to be applied to both of the ejector driver elements and the circulator driver elements.

8. The ejection head according to claim 7, further comprising a second control unit configured to drive the ejector driver elements in each of the ejector groups according to the number of time divisions, and drive the circulator driver elements in each of the circulator groups according to the number of time divisions.

9. The ejection head according to claim 3, further comprising a decoder circuit configured to expand a number of input bits in input data to a number of output bits of output data, where the number of output bits equals a number obtained by exponentiation using 2 as a base and the number of input bits as an exponent, the number of output bits being for use as a number of time divisions to be applied to both of the ejector driver elements and the circulator driver elements, wherein
the decoder circuit causes the output data to hold the ejection flag signal extracted from the input data.

10. The ejection head according to claim 4, further comprising a decoder circuit configured to expand a number of input bits in input data to a number of output bits of output data, where the number of output bits equals a number obtained by exponentiation using 2 as a base and the number of input bits as an exponent, the number of output bits being for use as a number of time divisions to be applied to both of the ejector driver elements and the circulator driver elements, wherein
the decoder circuit causes the output data to hold the circulation flag signal extracted from the input data.

11. The ejection head according to claim 1, wherein a common power supply voltage and a common ground potential are connected to the ejector heaters and the circulator heaters.

12. The ejection head according to claim 1, wherein the ejector heaters and the circulator heaters are manufactured in the same lot of a semiconductor manufacturing process.

13. The ejection head according to claim 1, wherein the ejector heaters and the circulator heaters are formed of a same material.

14. An ejection apparatus comprising:
an ejection head;
a carriage configured to mount the ejection head thereon and reciprocate in a main scanning direction; and
a conveyance roller provided below the carriage and configured to convey an ejection receiving medium in a sub scanning direction, wherein the ejection head includes
an ejector module including an ejector driver element and an ejector heater capable of connecting with the ejector driver element,
a circulator module arranged in a pair with the ejector module, and including a circulator driver element and a circulator heater capable of connecting with the circulator driver element,
a group selection circuit configured to be capable of selecting at least one ejector group from among ejector groups into which a plurality of the ejector modules are divided by a predetermined number, and selecting at least one circulator group from among circulator groups into which a plurality of the circulator modules are divided by the predetermined number, and
a control unit configured to determine whether or not to enable each of the selections by the group selection circuit based on an operation mode.
